(19) United States
(12) Patent Application Publication
(10) Pub. No.: US 2021/0323417 A1
(43) Pub. Date: Oct. 21, 2021

(54) POWER SUPPLY SYSTEM FOR VEHICLE

(71) Applicants: Hyundai Motor Company, Seoul (KR); Kia Motors Corporation, Seoul (KR)

(72) Inventors: Beom Joo Kwon, Suwon (KR); Min Wook Kim, Suwon (KR); Seung Min Yoo, Iksan (KR); Hui Tae Yang, Hwaseong (KR); Ji Woong Jung, Anyang (KR); Yun Jae Jung, Suwon (KR); Seok Mo Kang, Seoul (KR)

(21) Appl. No.: 17/035,069

(22) Filed: Sep. 28, 2020

(30) Foreign Application Priority Data
Apr. 20, 2020 (KR) 10-2020-0047711

(51) Int. Cl. B60L 50/64; B60L 50/51; B60L 53/16

(52) U.S. Cl. CPC B60L 50/64; B60L 50/51; B60L 2210/40; B60L 2220/46; B60L 53/16

(57) ABSTRACT

A vehicle power supply system includes a high-voltage battery pack that has a battery housing and a battery cell provided in the battery housing. A PRA is electrically connected to the battery cell. A first battery connector is provided at one side of the battery housing, a connecting member electrically connects the power relay assembly and the first battery connector, and a second battery connector is electrically connected to the power relay assembly and provided at the other side of the battery housing. A first junction box is electrically connected to a first power electronic module of a vehicle and has a first junction box connector. A first battery connecting cable electrically connects the first junction box connector and the first battery connector. A second battery connecting cable electrically connects the second battery connector and a second power electronic module of the vehicle.

### CROSS-REFERENCE TO RELATED APPLICATION

This application claims priority to and the benefit of Korean Patent Application No. 10-2020-0047711 filed on Apr. 20, 2020, the entire contents of which are incorporated herein by reference.

### TECHNICAL FIELD

The present disclosure relates to a power supply system for a vehicle, and more particularly, to a power supply system for a vehicle, which is capable of efficiently distributing power, simplifying a structure thereof, and reducing costs.

### BACKGROUND

Recently, environmentally-friendly vehicles such as electric vehicles or hybrid vehicles are increasing in sales, and the number of components using high-voltage batteries as energy sources is increasing as electrical components of the environmentally-friendly vehicles require high power. Meanwhile, the environmentally-friendly vehicle is provided with a junction box configured to interconnect various circuits in the vehicle and to regulate or control voltage.

However, in the related art, a plurality of junction boxes, which is configured to distribute power to different high-voltage components (e.g., a front-wheel motor and a rear-wheel motor), is connected in series to a high-voltage battery pack, and as a result, a wiring structure for electrically connecting the junction boxes and the high-voltage battery pack is complex, manufacturing costs are increased, and efficiency in distributing power to the high-voltage components deteriorates.

In addition, in the related art, the junction boxes need to be individually provided in accordance with optional specifications (e.g., options of four-wheel drive systems or options of two-wheel drive systems) of vehicles to meet customers' needs, and as a result, development and manufacturing costs are increased and maintenance and management costs are increased.

Therefore, recently, various types of research are conducted to efficiently distribute power to high-voltage components, simplify a structure, and reduce costs, but the research result is still insufficient. Accordingly, there is a need for development of a power supply system capable of efficiently distributing power to high-voltage components, simplifying a structure, and reducing costs.

### SUMMARY

An object of the present disclosure is to provide a power supply system for a vehicle, which is capable of efficiently distributing power, simplifying a structure, and reducing costs. Another object of the present disclosure is to simplify a structure of a junction box, reduce a size of the junction box, and simplify a wiring structure for electrically connecting the junction box and a high-voltage battery pack.

Still another object of the present disclosure is to shorten a power supply line and improve charging efficiency in comparison with a method of charging a battery via a junction box. Yet another object of the present disclosure is to improve a degree of freedom of arranging cables, improve a degree of design freedom and spatial utilization, and reduce a weight. Still yet another object of the present disclosure is to allow a high-voltage battery pack to share the function of distributing power, which is performed by a high-voltage junction box.

A further object of the present disclosure is to efficiently meet customers' needs (e.g., selection of vehicle options) and minimize development costs. Another further object of the present disclosure is to reduce the number of junction boxes in the case of a vehicle to which a low-speed charging option is applied. The object to be achieved by the exemplary embodiment is not limited to the above-mentioned objects, but also includes objects or effects that may be recognized from the solutions or the exemplary embodiments described below.

In addition to achieve the above-mentioned objects of the present disclosure, a power supply system for a vehicle according to the exemplary embodiment of the present disclosure may include a high-voltage battery pack having: a battery housing; a battery cell provided in the battery housing; a power relay assembly (PRA) electrically connected to the battery cell; a first battery connector provided at a first side of the battery housing; a connecting member configured to electrically connect the power relay assembly and the first battery connector; and a second battery connector electrically connected to the power relay assembly and provided at a second side of the battery housing; a first junction box electrically connected to a first power electronic module of a vehicle and provided with a first junction box connector; a first battery connecting cable configured to electrically connect the first junction box connector and the first battery connector; and a second battery connecting cable configured to electrically connect the second battery connector and a second power electronic module of the vehicle.

This is to efficiently distribute power, simplify a structure, and reduce costs. In other words, in the related art, to supply power with high voltage to a front-wheel motor and a rear-wheel motor of a vehicle, a first junction box is provided at a front side of the vehicle, a second junction box is provided at a rear side of the vehicle, a high-voltage battery pack and the second junction box are electrically connected with a first connecting cable, the high-voltage battery pack and the first junction box are electrically connected with a second connecting cable (e.g., connected in series via the second junction box) that connects the first junction box and the second junction box, and as a result, the second connecting cable inevitably needs to have a predetermined length or more.

In particular, in the related art, the second connecting cable, which electrically connects the high-voltage battery pack and the first junction box, is disposed to pass through a center tunnel provided to penetrate a center of the vehicle so that a driving shaft of the vehicle may pass through the center tunnel, and as a result, a length and a weight of the second connecting cable are increased and manufacturing costs are increased. Further, in the related art, since the high-voltage battery pack is charged via the second junction box, a power supply line (e.g., a charging line) for charging the high-voltage battery pack is inevitably increased and charging efficiency deteriorates.

In contrast, according to the exemplary embodiment of the present disclosure, the first junction box and the second junction box are not connected with a cable, but the first junction box and the second junction box are connected directly to the high-voltage battery pack via the first battery connecting cable and the second battery connecting cable. In other words, the first junction box is connected directly to the high-voltage battery pack with the first battery connecting cable, and the second junction box is connected directly to the high-voltage battery pack with the second battery connecting cable. As a result, it may be possible to obtain an advantageous effect of excluding the cable that connects the first junction box and the second junction box, minimizing an increase in lengths and weights of the first battery connecting cable and the second battery connecting cable, and reducing costs.

In addition, according to the exemplary embodiment of the present disclosure, the charging line for charging the high-voltage battery pack is connected directly to the high-voltage battery pack without passing through the second junction box (or the first junction box), and as a result, it may be possible to obtain an advantageous effect of shortening the charging line for charging the high-voltage battery pack, and improving charging efficiency.

According to the exemplary embodiment of the present disclosure, various members capable of electrically connecting the power relay assembly and the first battery connector in the battery housing may be used as the connecting member. In particular, the connecting member may include at least one of a cable and a busbar.

According to the exemplary embodiment of the present disclosure, the first power electronic module of the vehicle may include: a front-wheel motor of the vehicle; and a front-wheel inverter electrically connected to the front-wheel motor and configured to convert direct current power, which is supplied from the high-voltage battery pack, into alternating current (AC) power, and the second power electronic module of the vehicle may include: a rear-wheel motor of the vehicle; and a rear-wheel inverter electrically connected to the rear-wheel motor and configured to convert direct current (DC) power, which is supplied from the high-voltage battery pack, into alternating current power.

According to the exemplary embodiment of the present disclosure, the power supply system for a vehicle may include a second junction box electrically connected to the second power electronic module of the vehicle and provided with a second junction box connector, in which the second battery connecting cable electrically connects the second junction box connector and the second battery connector. In particular, the power supply system for a vehicle may include a second junction box busbar provided in the second junction box, and the second power electronic module may be electrically connected to the second junction box busbar.

According to the exemplary embodiment of the present disclosure, the power supply system for a vehicle may include a high-speed charging unit provided in the second junction box. The high-speed charging unit may have various structures capable of charging the high-voltage battery pack at a high speed. As an example, the high-speed charging unit may include: a high-speed charging relay provided in the second junction box; and a high-speed charging connector provided in the second junction box and electrically connected to the high-speed charging relay.

In addition, according to the exemplary embodiment of the present disclosure, the power supply system for a vehicle may include a low-speed charging unit provided in the battery housing. The low-speed charging unit may have various structures capable of charging the high-voltage battery pack at a low speed. As an example, the low-speed charging unit may include: a base member disposed in the battery housing; a low-speed charging connector provided on the base member and electrically connected to the power relay assembly; and a low-speed charging fuse provided on the base member and configured to selectively cut off a supply of power to the low-speed charging connector.

In particular, the low-speed charging unit may be disposed in an edge region of the battery housing to be adjacent to the power relay assembly. As described above, since the low-speed charging unit may be mounted adjacent to the power relay assembly using a vacant space provided at the edge of the battery housing, it may be possible to mount the low-speed charging unit without changing the structure of the battery housing and to obtain an advantageous effect of simplifying a wiring structure for electrically connecting the low-speed charging unit and the power relay assembly.

According to another exemplary embodiment of the present disclosure, the power supply system for a vehicle may include a low-speed charging unit provided outside the battery pack and electrically connected to the high-voltage battery pack. As an example, the low-speed charging unit may include: a base member disposed outside the battery housing; a low-speed charging connector provided on the base member and electrically connected to the power relay assembly; and a fuse provided on the base member and configured to selectively cut off a supply of power to the low-speed charging connector.

### BRIEF DESCRIPTION OF THE DRAWINGS

The above and other features of the present disclosure will now be described in detail with reference to exemplary embodiments thereof illustrated in the accompanying drawings which are given hereinbelow by way of illustration only, and thus are not limitative of the present invention, and wherein:

FIG. 1 is a view illustrating a power supply system for a vehicle according to an exemplary embodiment of the present disclosure.

FIG. 2 is a view illustrating a high-voltage battery pack in the power supply system for a vehicle according to the exemplary embodiment of the present disclosure.

FIG. 3 is a view illustrating a first junction box in the power supply system for a vehicle according to the exemplary embodiment of the present disclosure.

FIG. 4 is a view illustrating a second junction box in the power supply system for a vehicle according to the exemplary embodiment of the present disclosure.

FIG. 5 is a view illustrating a low-speed charging unit in the power supply system for a vehicle according to the exemplary embodiment of the present disclosure.

FIG. 6 is a view illustrating a circuit configuration of a power relay assembly and a circuit configuration of the low-speed charging unit in the power supply system for a vehicle according to the exemplary embodiment of the present disclosure.

FIGS. 7 and 8 are views illustrating examples in which the first junction box and the second junction box are applied to the power supply system for a vehicle according to the exemplary embodiment of the present disclosure.

FIG. 9 is a view illustrating a power supply system for a vehicle according to another exemplary embodiment of the present disclosure.

FIGS. 10 and 11 are views illustrating an example in which the first junction box is applied to the power supply system for a vehicle according to another exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, exemplary embodiments of the present disclosure will be described in detail with reference to the accompanying drawings. However, the technical spirit of the present disclosure is not limited to some exemplary embodiments described herein but may be implemented in various different forms. One or more of the constituent elements in the exemplary embodiments may be selectively combined and substituted within the scope of the technical spirit of the present disclosure.

In addition, unless otherwise specifically and explicitly defined and stated, the terms (including technical and scientific terms) used in the exemplary embodiments of the present disclosure may be construed as the meaning which may be commonly understood by the person with ordinary skill in the art to which the present disclosure pertains. The meanings of the commonly used terms such as the terms defined in dictionaries may be interpreted in consideration of the contextual meanings of the related technology.

In addition, the terms used in the exemplary embodiment of the present disclosure are for explaining the exemplary embodiments, not for limiting the present disclosure. Unless particularly stated otherwise in the context of the present specification, a singular form may also include a plural form. The explanation “at least one (or one or more) of A, B, and C” described herein may include one or more of all combinations that can be made by combining A, B, and C. In addition, the terms such as first, second, A, B, (a), and (b) may be used to describe constituent elements of the exemplary embodiments of the present disclosure.

These terms are used only for the purpose of discriminating one constituent element from another constituent element, and the nature, the sequences, or the orders of the constituent elements are not limited by the terms. Further, when one constituent element is described as being ‘connected’, ‘coupled’, or ‘attached’ to another constituent element, one constituent element can be connected, coupled, or attached directly to another constituent element or connected, coupled, or attached to another constituent element through still another constituent element interposed therebetween.

In addition, the explanation “one constituent element is formed or disposed above (on) or below (under) another constituent element” includes not only a case in which the two constituent elements are in direct contact with each other, but also a case in which one or more additional constituent elements are formed or disposed between the two constituent elements. In addition, the expression “up (above) or down (below)” may include a meaning of a downward direction as well as an upward direction based on one constituent element.

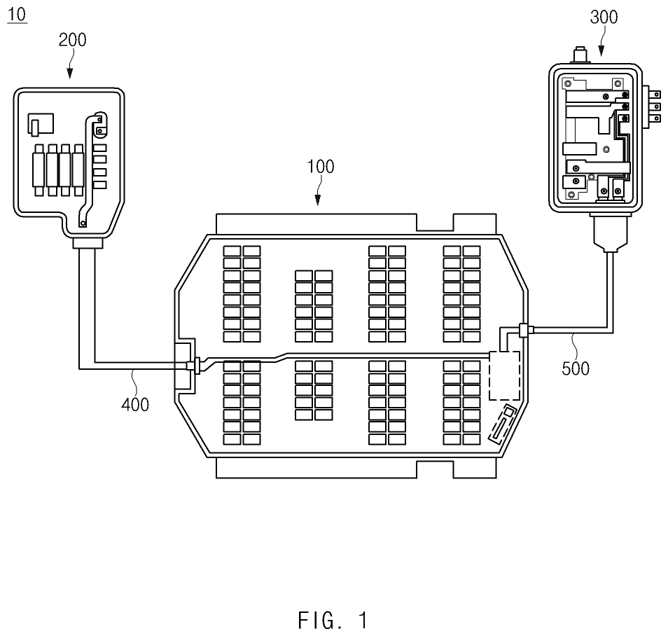

Referring to FIGS. 1 to 11, a power supply system 10 for a vehicle according to the present disclosure may include: a high-voltage battery pack 100 having a battery housing 110, battery cells 120 provided in the battery housing 110, a power relay assembly (PRA) 160 electrically connected to the battery cells 120, a first battery connector 130 provided at a first side of the battery housing 110, a connecting member 140 configured to electrically connect a power relay assembly 160 and the first battery connector 130, and a second battery connector 150 electrically connected to the power relay assembly 160 and provided at a second side of the battery housing 110; a first junction box 200 electrically connected to a first power electronic module of a vehicle 20 and having with a first junction box connector 220; a first battery connecting cable 400 configured to electrically connect the first junction box connector 220 and the first battery connector 130; and a second battery connecting cable 500 configured to electrically connect the second battery connector 150 and a second power electronic module of the vehicle 20.

For reference, the power supply system 10 for a vehicle according to the exemplary embodiment of the present disclosure may be applied to environmentally-friendly vehicles such as electric vehicles or hybrid vehicles or to other vehicles to which high-voltage components are applied, and the present disclosure is not restricted or limited by the type and the property of the vehicle 20 to which the power supply system 10 for a vehicle is applied.

As an example, the power supply system 10 for a vehicle according to the exemplary embodiment of the present disclosure may be used to supply and distribute power to the environmentally-friendly vehicle 20 such as an electric vehicle, a fuel cell vehicle, or a hybrid vehicle. The high-voltage battery pack 100 is provided in the vehicle 20 to store and supply electrical energy.

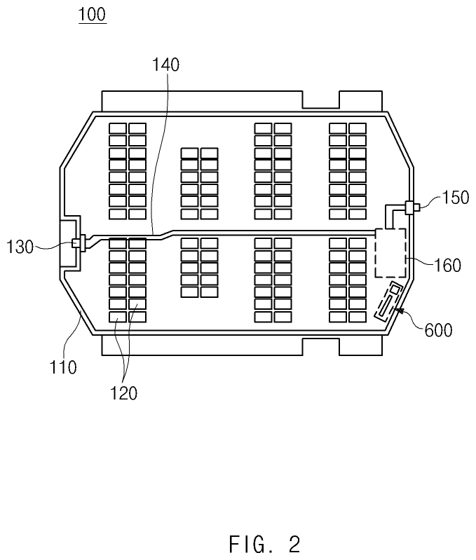

More specifically, referring to FIG. 2, the high-voltage battery pack 100 may include the battery housing 110, the battery cells 120 provided in the battery housing 110, the power relay assembly (PRA) 160 electrically connected to the battery cells 120, the first battery connector 130 provided at a first side of the battery housing 110, the connecting member 140 configured to electrically connect the power relay assembly 160 and the first battery connector 130, and the second battery connector 150 electrically connected to the power relay assembly 160 and provided at a second side of the battery housing 110.

The battery housing 110 may have various structures having a receiving space therein, and the present disclosure is not restricted or limited by the shape and the structure of the battery housing 110. In the battery housing 110, the plurality of battery cells (e.g., unit cells) 120 may be disposed to be connected to each other in series, in parallel, or in a combination of series and parallel, and the number of battery cells 120 and the structure for arranging and connecting the battery cells 120 may be variously changed in accordance with required conditions and design specifications.

The power relay assembly 160 may be disposed in the battery housing 110 to electrically connect or disconnect the battery cells 120 and various types of components (e.g., motors, battery heaters, air conditioner compressors, solar roof converters, indoor air conditioning PTC heaters, and the like) using high voltage. The power relay assembly 160 may have various structures capable of serving as a switch that may connect or disconnect the battery cells 120 and various types of components, and the present disclosure is not restricted or limited by the structure of the power relay assembly 160.

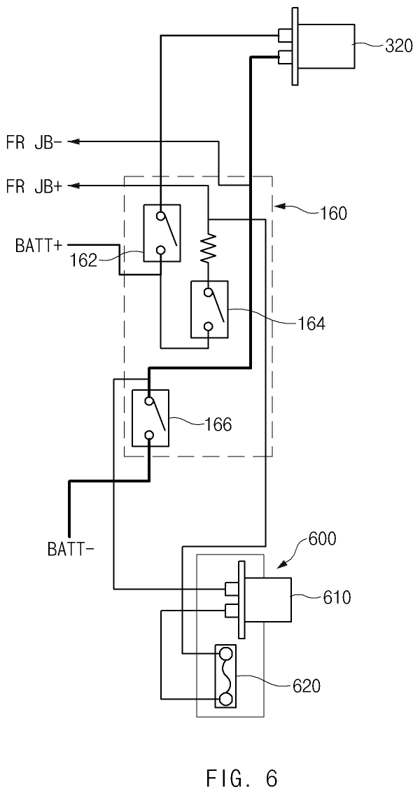

As an example, referring to FIG. 6, the power relay assembly 160 may include a first relay 162 configured to electrically connect or disconnect a second junction box connector 320 (a positive terminal (+) of the second junction box connector) and a positive terminal (+) of the battery cell, a second relay 164 configured to electrically connect or disconnect the positive terminal (+) of the battery cell 120 and the first junction box connector 220 (a positive terminal (+) of the first junction box connector), a third relay 166 configured to electrically connect or disconnect a negative terminal (−) of the battery cell 120 and the second junction box connector 320 (a negative terminal (−) of the second junction box connector), and a precharge resistor (not illustrated) configured to use variable resistance (adjustable resistance values).

For reference, a contact relay, a contactless relay, a positive temperature coefficient

(PTC) switching element, or the like may be used as the first to third relays 162, 164, and 166, and the present disclosure is not restricted or limited by the types and the structures of the first to third relays 162, 164, and 166. The first battery connector 130 may be provided at a first side of the battery housing 110 to be exposed out of the battery housing 110. As an example, referring to FIG. 2, the first battery connector 130 may be provided at a left end of the battery housing 110.

The first battery connector 130 may have various structures to which the first battery connecting cable 400 may be electrically connected, and the present disclosure is not restricted or limited by the shape and the structure of the first battery connector 130. The connecting member 140 may be disposed to electrically connect the power relay assembly 160 and the first battery connector 130.

Various members capable of electrically connecting the power relay assembly 160 and the first battery connector 130 in the battery housing 110 may be used as the connecting member 140, and the present disclosure is not restricted or limited by the type of connecting member 140 and the structure for arranging the connecting member 140. In particular, the connecting member 140 may include at least one of a cable and a busbar.

As an example, the connecting member 140 may be disposed to cross the interior of the battery housing 110 in a transverse direction (based on FIG. 2). The second battery connector 150 may be electrically connected to the power relay assembly 160 (e.g., a first terminal and a third terminal of the power relay assembly). The second battery connector 150 may be provided at a second side of the battery housing 110 to be exposed out of the battery housing 110. As an example, referring to FIG. 2, the second battery connector 150 may be provided at a right end of the battery housing 110. The second battery connector 150 may have various structures to which the second battery connecting cable 500 may be electrically connected, and the present disclosure is not restricted or limited by the shape and the structure of the second battery connector 150.

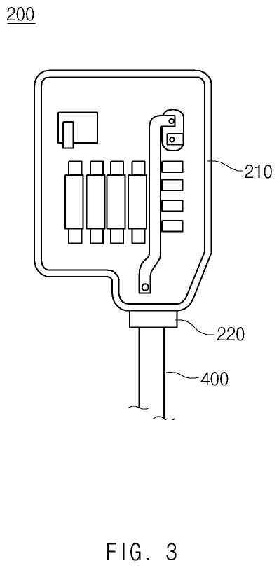

Referring to FIG. 3, the first junction box 200 may be electrically connected to the first power electronic module of the vehicle 20 and has the first junction box connector 220. The first power electronic module of the vehicle 20 may include a front-wheel motor 31 of the vehicle 20, and a front-wheel inverter 31a electrically connected to the front-wheel motor 31 and configured to convert direct current power, which is supplied from the high-voltage battery pack 100, into alternating current power. The first junction box 200 may have various structures capable of interconnecting various circuits related to the first power electronic module and regulating and adjusting the voltage, and the present disclosure is not restricted or limited by the structure of the first junction box 200.

As an example, the first junction box 200 may include a first junction box housing 210 having a receiving space therein, a first junction box busbar (not illustrated) provided in the first junction box housing 210 and electrically coupled to the first power electronic module (e.g., the front-wheel motor), a first junction box relay (not illustrated) provided in the first junction box housing 210 and configured to allow or cut off a supply of power to the first power electronic module, and a first junction box fuse (not illustrated) provided in the first junction box housing 210 and configured to selectively cut off the supply of power to the first power electronic module (block the overcurrent). The first junction box connector 220 may be provided at a first side of the first junction box housing 210 to be exposed to the outside.

The first battery connecting cable 400 may be disposed to electrically connect the first junction box connector 220 and the first battery connector 130. More specifically, a first end of the first battery connecting cable 400 may be connected to the first junction box connector 220, and a second end of the first battery connecting cable 400 may be connected to the first battery connector 130.

A typical high-voltage cable capable of electrically connecting the first junction box connector 220 and the first battery connector 130 may be used as the first battery connecting cable 400, and the present disclosure is not restricted or limited by the type and the property of the first battery connecting cable 400. The second battery connecting cable 500 may be disposed to electrically connect the second power electronic module of the vehicle 20 and the second battery connector 150.

The second power electronic module of the vehicle 20 may include a rear-wheel motor 32 of the vehicle 20, and a rear-wheel inverter 32a electrically connected to the rear-wheel motor 32 and configured to convert direct current power, which is supplied from the high-voltage battery pack 100, into alternating current power. More specifically, a first end of the second battery connecting cable 500 may be connected to the second battery connector 150, and a second end of the second battery connecting cable 500 may be connected to the second power electronic module of the vehicle 20. A typical high-voltage cable capable of electrically connecting the second battery connector 150 and the second power electronic module of the vehicle 20 may be used as the second battery connecting cable 500, and the present disclosure is not restricted or limited by the type and the property of the second battery connecting cable 500.

According to the exemplary embodiment of the present disclosure, the power supply system 10 for a vehicle may include a second junction box 300 electrically connected to the second power electronic module of the vehicle 20 and provided with the second junction box connector 320, and the second battery connecting cable 500 may electrically connect the second junction box connector 320 and the second battery connector 150 (see FIG. 1).

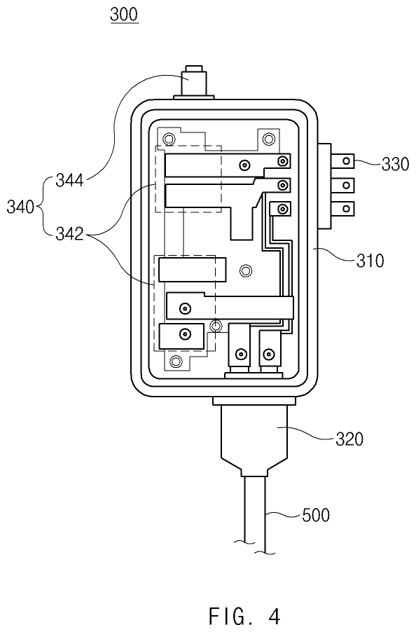

Referring to FIG. 4, the second junction box 300 may be electrically connected to the second power electronic module of the vehicle 20 and provided with the second junction box connector 320. The second junction box 300 may have various structures capable of interconnecting various circuits related to the second power electronic module and regulating and adjusting the voltage, and the present disclosure is not restricted or limited by the structure of the second junction box 300.

As an example, the second junction box 300 may include a second junction box housing 310 having a receiving space therein, a second junction box relay (not illustrated) provided in the second junction box housing 310 and configured to allow or cut off a supply of power to the second power electronic module, and a second junction box fuse (not illustrated) provided in the second junction box housing 310 and configured to selectively cut off the supply of power to the second power electronic module (block the overcurrent). The second junction box connector 320 may be provided at a first side of the second junction box housing 310 to be exposed to the outside. In particular, the second junction box 300 may include a second junction box busbar 330 provided in the second junction box housing 310, and the second power electronic module (e.g., the rear-wheel motor) may be electrically connected to the second junction box busbar 330.

According to the exemplary embodiment of the present disclosure, the power supply system 10 for a vehicle may include a high-speed charging unit 340 provided in the second junction box 300. For reference, in the exemplary embodiment of the present disclosure, the term ‘high-speed charging’ may be defined as a method of charging the high-voltage battery pack 100 by variably supplying the direct current of about 100 to 450 V or the alternating current of about 380 V.

The high-speed charging unit 340 may have various structures capable of charging the high-voltage battery pack 100 at a high speed, and the structure and the circuit configuration of the high-speed charging unit 340 may be variously changed in accordance with required conditions and design specifications. As an example, the high-speed charging unit 340 may include a high-speed charging relay 342 provided in the second junction box 300 and configured to allow or cut off a supply of power to the high-voltage battery pack 100 (charge the high-voltage battery pack 100), and a high-speed charging connector 344 provided on the second junction box 300 and electrically connected to the high-speed charging relay 342. A high-speed charging port (not illustrated), to which an external charger is connected, may be electrically connected to the high-speed charging connector 344.

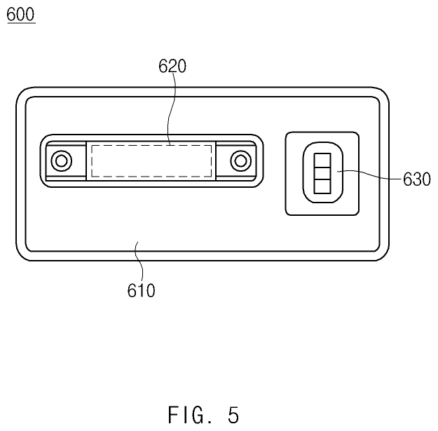

For reference, a contact relay, a contactless relay, a positive temperature coefficient (PTC) switching element, or the like may be used as the high-speed charging relay 342, and the present disclosure is not restricted or limited by the type and the structure of the high-speed charging relay 342. In addition, referring to FIGS. 5 and 6, according to the exemplary embodiment of the present disclosure, the power supply system 10 for a vehicle may include a low-speed charging unit 600 provided in the battery housing 110.

For reference, according to the exemplary embodiment of the present disclosure, the term ‘low-speed charging’ may be defined as a method of charging the high-voltage battery pack 100 by supplying the alternating current of about 220 V. In particular, the low-speed charging unit 600 is provided by combining a function of a battery charger (e.g., on-board charger (OBC)) and a function of a low-voltage direct current converter (LDC), the battery charger (OBC) may be configured to charge the high-voltage battery pack 100 by converting the alternating current (AC), which is a commercially available power source, into the direct current (DC), and the low-voltage direct current converter (LDC) reduces the current with the high voltage (e.g., about 270 V) to the current with the low voltage (e.g., about 12 V).

The low-speed charging unit 600 may have various structures capable of charging the high-voltage battery pack 100 at a low speed, and the structure and the circuit configuration of the low-speed charging unit 600 may be variously changed in accordance with required conditions and design specifications. As an example, the low-speed charging unit 600 may include a base member 610 disposed in the battery housing 110, a low-speed charging connector 620 mounted on the base member 610 and electrically connected to the power relay assembly 160, and a low-speed charging fuse 630 mounted on the base member 610 and configured to selectively cut off a supply of power to the low-speed charging connector 620.

In particular, a negative terminal (−) (not illustrated) of the low-speed charging connector 620 may be electrically connected to a negative terminal (−) (not illustrated) of the second junction box connector 320 and a negative terminal (−) (not illustrated) of the first junction box connector 220, and the low-speed charging fuse 630 may be electrically connected to a positive terminal (+) (not illustrated) of the low-speed charging connector 620 and a positive terminal (+) (not illustrated) of the first junction box connector 220.

More particularly, the low-speed charging unit 600 may be disposed in an edge region of the battery housing 110 to be adjacent to the power relay assembly 160. As described above, since the low-speed charging unit 600 may be mounted adjacent to the power relay assembly 160 using a vacant space provided at the edge of the battery housing 110, it may be possible to mount the low-speed charging unit 600 without changing the structure of the battery housing 110 and to obtain an advantageous effect of simplifying a wiring structure for electrically connecting the low-speed charging unit 600 and the power relay assembly 160.

In the exemplary embodiment of the present disclosure described above and illustrated in the drawings, the configuration in which the low-speed charging unit 600 is integrally mounted in the high-voltage battery pack 100 has been described as an example. However, according to another exemplary embodiment of the present disclosure, the low-speed charging unit may be mounted separately from the high-voltage battery pack.

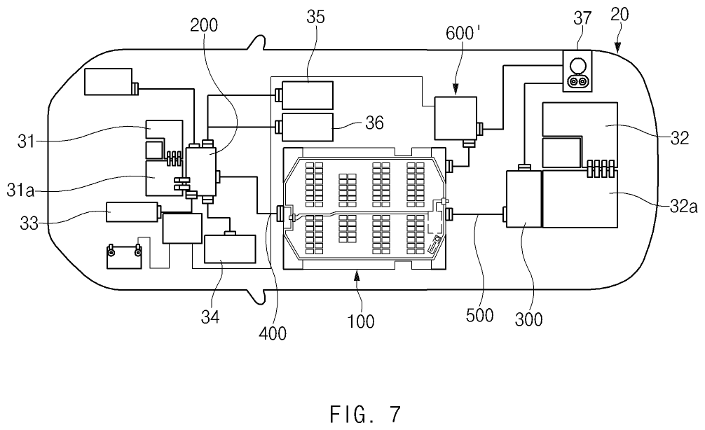

As an example, referring to FIG. 7, the power supply system 10 for a vehicle may include the high-voltage battery pack 100, a first junction block, a second junction block, and a low-speed charging unit 600′ provided outside the high-voltage battery pack 100 independently of the second junction box 300 and electrically connected to the high-voltage battery pack 100. The low-speed charging unit 600′ may have various structures mounted outside the high-voltage battery pack 100 and capable of charging the high-voltage battery pack 100 at a low speed.

As an example, the low-speed charging unit 600′ may include the base member 610 disposed outside the battery housing 110, the low-speed charging connector 620 provided on the base member 610 and electrically connected to the power relay assembly 160, and a fuse provided on the base member 610 and configured to selectively cut off the supply of power to the low-speed charging connector 620. For example, the low-speed charging connector 620 may be electrically connected to a connector (not illustrated) which is provided in the battery housing 110 to be electrically connected to the power relay assembly 160.

In addition, an inlet 37, to which an external charger is connected, may be electrically connected to the low-speed charging unit 600′. In particular, a combo-type inlet 37 capable of performing both the high-speed charging and the low-speed charging may be used as the inlet 37, and the second junction box 300 is electrically connected to the inlet 37.

Meanwhile, in addition to the first power electronic module of the vehicle 20, other high-voltage components may be electrically connected to the first junction box 200. As an example, referring to FIG. 7, a wireless charging module 33 configured to charge the high-voltage battery pack 100 in a wireless manner, a battery heater 34, a solar roof converter 35, and an indoor air conditioning PTC heater 36 may be electrically connected to the first junction box 200. The type of high-voltage component and the number of high-voltage components electrically connected to the first junction box 200 may be variously changed in accordance with required conditions and design specifications, and the present disclosure is not restricted or limited by the type of high-voltage component and the number of high-voltage components.

Further, in the exemplary embodiment of the present disclosure described above and illustrated in the drawings, the configuration in which the power supply system 10 for a vehicle is applied to the vehicle option enabling a four-wheel drive system has been described as an example. However, according to another exemplary embodiment of the present disclosure, the power supply system for a vehicle may be applied to the vehicle option that enables a two-wheel drive system (e.g., a rear-wheel drive system).

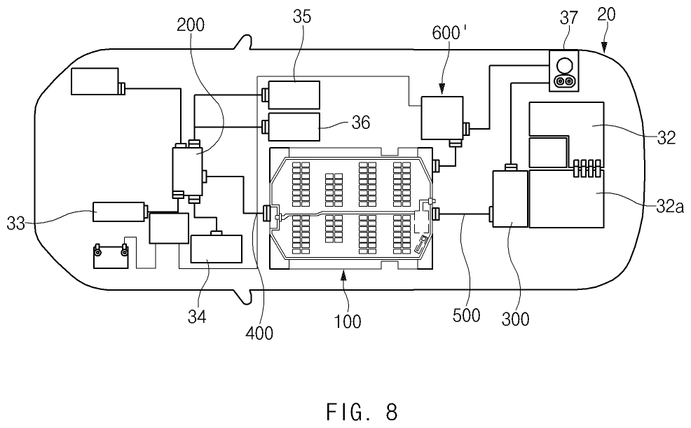

In other words, referring to FIG. 8, the power supply system 10 for a vehicle according to another exemplary embodiment of the present disclosure may include the high-voltage battery pack 100, the first junction box 200, the second junction box 300, the first battery connecting cable 400, and the second battery connecting cable 500, in which the second power electronic module may be electrically connected to the second junction box 300, and only the high-voltage components (e.g., the wireless charging module, the battery heater, the solar roof converter, and the indoor air conditioning PTC heater) other than the first power electronic module may be electrically connected to the first junction box 200.

In addition, in the exemplary embodiment of the present disclosure described above and illustrated in the drawings, the configuration in which the power supply system 10 for a vehicle is applied to the vehicle option enabling both the low-speed charging and the high-speed charging has been described as an example. However, according to another exemplary embodiment of the present disclosure, the power supply system for a vehicle may be applied to the vehicle option that enables only the low-speed charging.

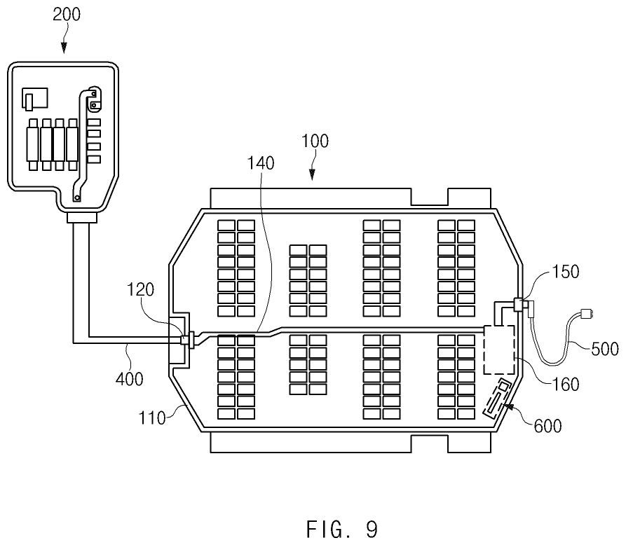

As an example, referring to FIG. 9, the power supply system 10 for a vehicle according to another exemplary embodiment of the present disclosure may include the high-voltage battery pack 100, the first junction box 200, the first battery connecting cable 400, the second battery connecting cable 500, and the low-speed charging unit 600 provided in the battery pack, in which the second battery connecting cable 500 may be connected directly to the second power electronic module without separately passing through the second junction box 300.

As described above, in the exemplary embodiment of the present disclosure, since the low-speed charging unit 600 is integrally provided in the high-voltage battery pack 100, it may be possible to electrically connect the high-voltage battery pack 100 and the second power electronic module without separately providing the second junction box 300, thereby obtaining an advantageous effect of simplifying the entire structure of the power supply system 10 for a vehicle and reducing costs.

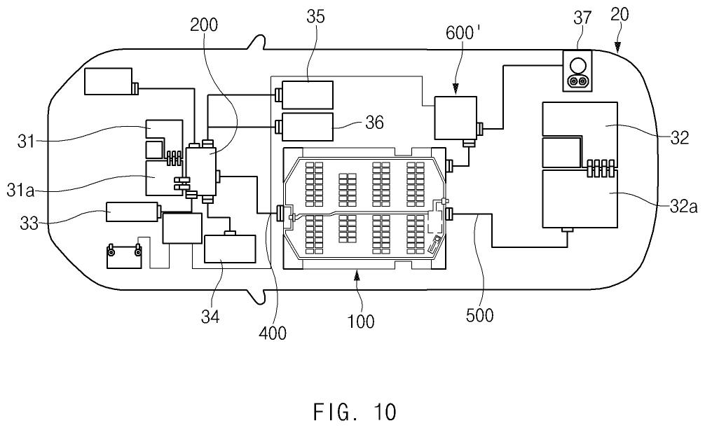

As another example, according to another exemplary embodiment of the present disclosure, the power supply system for a vehicle may be applied to the vehicle option in which the four-wheel drive system is provided and only the low-speed charging is possible. In other words, referring to FIG. 10, the power supply system 10 for a vehicle according to another exemplary embodiment of the present disclosure may include the high-voltage battery pack 100, the first junction box 200, the first battery connecting cable 400, the second battery connecting cable 500, and the low-speed charging unit 600′ provided outside the battery pack, in which the second battery connecting cable 500 may be connected directly to the second power electronic module without separately passing through the second junction box 300.

As described above, in the exemplary embodiment of the present disclosure, since the low-speed charging unit 600′ is provided outside the high-voltage battery pack 100 independently of the second junction box 300, it may be possible to electrically connect the high-voltage battery pack 100 and the second power electronic module without separately providing the second junction box 300, thereby obtaining an advantageous effect of simplifying the entire structure of the power supply system 10 for a vehicle and reducing costs.

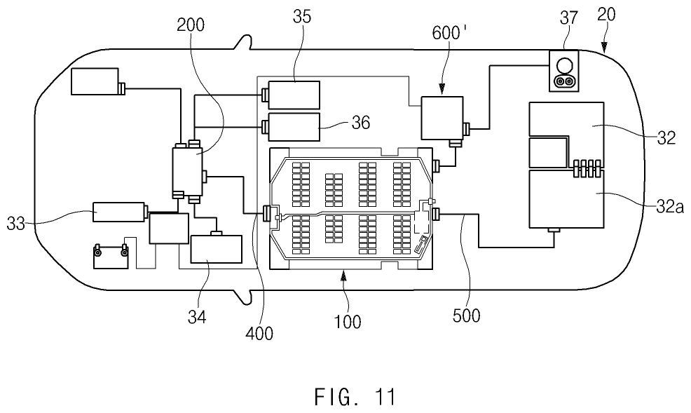

As still another example, according to another exemplary embodiment of the present disclosure, the power supply system for a vehicle may be applied to the vehicle option in which the two-wheel drive system (e.g., the rear-wheel drive system) is provided and only the low-speed charging is possible. In other words, referring to FIG. 11, the power supply system 10 for a vehicle according to another exemplary embodiment of the present disclosure may include the high-voltage battery pack 100, the first junction box 200, the first battery connecting cable 400, the second battery connecting cable 500, and the low-speed charging unit 600′ provided outside the battery pack, in which the second battery connecting cable 500 may be connected directly to the second power electronic module without separately passing through the second junction box 300, and only the other high-voltage components (e.g., the wireless charging module, the battery heater, the solar roof converter, and the indoor air conditioning PTC heater) other than the first power electronic module may be electrically connected to the first junction box 200.

As described above, in the exemplary embodiment of the present disclosure, since the low-speed charging unit 600′ is provided outside the high-voltage battery pack 100 independently of the second junction box 300, it may be possible to electrically connect the high-voltage battery pack 100 and the second power electronic module without separately providing the second junction box 300, thereby obtaining an advantageous effect of simplifying the entire structure of the power supply system 10 for a vehicle and reducing costs.

While the exemplary embodiments have been described above, but the exemplary embodiments are just illustrative and not intended to limit the present disclosure. It may be appreciated by those skilled in the art that various modifications and alterations, which are not described above, may be made to the present exemplary embodiment without departing from the intrinsic features of the present exemplary embodiment. For example, the respective constituent elements specifically described in the exemplary embodiments may be modified and then carried out. Further, it should be interpreted that the differences related to the modifications and alterations are included in the scope of the present disclosure defined by the appended claims.

According to the present disclosure described above, it may be possible to obtain an advantageous effect of efficiently distributing power, simplifying the structure, and reducing costs. In particular, according to the exemplary embodiment of the present disclosure, it may be possible to obtain an advantageous effect of simplifying the structure of the junction box, reducing the size of the junction box, and simplifying the wiring structure for electrically connecting the junction box and the high-voltage battery pack.

In addition, according to the exemplary embodiment of the present disclosure, it may be possible to obtain an advantageous effect of shortening the power supply line and improving charging efficiency in comparison with a method of charging a battery via a junction box. According to the exemplary embodiment of the present disclosure, it may be further possible to obtain an advantageous effect of improving a degree of freedom of arranging the cables, improving a degree of design freedom and spatial utilization, and reducing a weight.

Further, according to the exemplary embodiment of the present disclosure, it may be possible to obtain an advantageous effect of allowing the high-voltage battery pack to share the function of distributing power, which is performed by the high-voltage junction box. In addition, according to the exemplary embodiment of the present disclosure, it may be possible to obtain an advantageous effect of efficiently meeting customers' needs (e.g., selection of vehicle options) and minimizing development costs.

According to the exemplary embodiment of the present disclosure, a rear junction box (e.g., a junction box connected to a motor of a rear-wheel drive system) may be omitted form being mounted in the case of the vehicle to which the low-speed charging option is applied, and as a result, it may be possible to obtain an advantageous effect of reducing the total number of junction boxes and improving spatial utilization and a degree of design freedom.

What is claimed is:

1. A power supply system for a vehicle, the power supply system, comprising:
a high-voltage battery pack including:
a battery housing;
a battery cell provided in the battery housing;
a power relay assembly (PRA) electrically connected to the battery cell;
a first battery connector provided at a first side of the battery housing;
a connecting member configured to electrically connect the power relay assembly and the first battery connector; and
a second battery connector electrically connected to the power relay assembly and provided at a second side of the battery housing;
a first junction box electrically connected to a first power electronic module of a vehicle and provided with a first junction box connector;
a first battery connecting cable configured to electrically connect the first junction box connector and the first battery connector; and
a second battery connecting cable configured to electrically connect the second battery connector and a second power electronic module of the vehicle.

2. The power supply system of claim 1, further comprising:
a second junction box electrically connected to the second power electronic module of the vehicle and provided with a second junction box connector,
wherein the second battery connecting cable electrically connects the second junction box connector and the second battery connector.

3. The power supply system of claim 2, further comprising:
a busbar provided in the second junction box and electrically connected to the second junction box connector,
wherein the second power electronic module of the vehicle is electrically connected to the busbar.

4. The power supply system of claim 2, further comprising:
a high-speed charging unit provided in the second junction box.

5. The power supply system of claim 4, wherein the high-speed charging unit includes:
a high-speed charging relay provided in the second junction box; and
a high-speed charging connector provided in the second junction box and electrically connected to the high-speed charging relay.

6. The power supply system of claim 4, further comprising:
a low-speed charging unit provided outside the high-voltage battery pack independently of the second junction box and electrically connected to the high-voltage battery pack.

7. The power supply system of claim 6, wherein the low-speed charging unit include:
a base member disposed outside the battery housing;
a low-speed charging connector provided on the base member and electrically connected to the power relay assembly; and
a fuse provided on the base member and configured to selectively cut off a supply of power to the low-speed charging connector.

8. The power supply system of claim 1, further comprising:
a low-speed charging unit provided in the battery housing.

9. The power supply system of claim 8, wherein the low-speed charging unit includes:
a base member disposed in the battery housing;
a low-speed charging connector provided on the base member and electrically connected to the power relay assembly; and
a fuse provided on the base member and configured to selectively cut off a supply of power to the low-speed charging connector.

10. The power supply system of claim 8, wherein the low-speed charging unit is disposed in an edge region of the battery housing to be adjacent to the power relay assembly.

11. The power supply system of claim 1, wherein the connecting member includes at least one of a cable and a busbar.

12. The power supply system of claim 1, wherein the first power electronic module includes:
a front-wheel motor of the vehicle; and
a front-wheel inverter electrically connected to the front-wheel motor and configured to convert direct current power, which is supplied from the high-voltage battery pack, into alternating current power.

13. The power supply system of claim 12, wherein the second power electronic module includes:
a rear-wheel motor of the vehicle; and
a rear-wheel inverter electrically connected to the rear-wheel motor and configured to convert direct current power, which is supplied from the high-voltage battery pack, into alternating current power.
